(19) United States
(12) Patent Application Publication
(10) Pub. No.: US 2022/0156585 A1
(43) Pub. Date: May 19, 2022

(54) TRAINING POINT CLOUD PROCESSING NEURAL NETWORKS USING PSEUDO-ELEMENT - BASED DATA AUGMENTATION

(71) Applicant: Waymo LLC, Mountain View, CA (US)

(72) Inventors: Zhaoqi Leng, Milpitas, CA (US); Shuyang Cheng, Santa Clara, CA (US); Weiyue Wang, Sunnyvale, CA (US); Xiao Zhang, Los Altos, CA (US); Dragomir Anguelov, San Francisco, CA (US)

(21) Appl. No.: 17/526,731

(22) Filed: Nov. 15, 2021

Related U.S. Application Data
(60) Provisional application No. 63/114,508, filed on Nov. 16, 2020.

(51) Int. Cl. G06N 3/08; G06K 9/62

(52) U.S. Cl. CPC G06N 3/08; G06K 9/6262; G06K 9/6259; G06K 9/623

(57) ABSTRACT

Methods, computer systems, and apparatus, including computer programs encoded on computer storage media, for performing training of a neural network that is configured to process a network input comprising a point cloud to generate a network output for a point cloud processing task. The system obtains a set of labeled training examples and a set of unlabeled point clouds, generates a respective pseudo-label for each unlabeled point cloud, generates a plurality of pseudo-elements based on the respective pseudo-label for the unlabeled point cloud, generates augmented training data by augmenting the labeled training examples using the pseudo-elements generated for the unlabeled point clouds, and performing training of the neural network on the augmented training data.

### CROSS-REFERENCE TO RELATED APPLICATION

This application claims priority to U.S. Provisional Patent Application No. 63/114,508, filed on Nov. 16, 2020, the disclosure of which is hereby incorporated by reference in its entirety.

### BACKGROUND

This specification relates to training neural networks that operate on point clouds.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a point cloud processing neural network that is configured to perform a point cloud processing task on both labeled training examples and unlabeled point clouds.

In other words, the neural network being trained is configured to process a network input that includes a point cloud to generate a network output for the point cloud processing task.

The point cloud processing task can be any appropriate task that requires the neural network to process a point cloud. One example of such a task is object detection, where the network output identifies regions of the point cloud that are predicted to correspond to objects. Another example of such a task is trajectory prediction, where the network output predicts future trajectories for one or more agents that are characterized by the point cloud. Yet another example of such a task is point cloud segmentation, where the network output assigns each point in the point cloud to a respective class, e.g., that segments the image into background and foreground classes or that segments the point cloud into classes that correspond to different object types.

Each of the labeled training examples includes (i) a point cloud and (ii) a respective label for the point cloud that specifies a target network output (for the point clod processing task) to be generated by the neural network by processing the point cloud.

The unlabeled point clouds are point clouds for which a label is not available to the system for use in training the neural network.

The system can incorporate the unlabeled point clouds into the training by generating a respective pseudo-label for each unlabeled point cloud that is a prediction of a label for the unlabeled point cloud. In some cases, this is done by processing the unlabeled point cloud using a pre-trained neural network. In other cases, the system repeatedly generates sets of pseudo-labels at different training iterations during the performance of a training process to train the neural network. In these cases, the system can use one or more instances of the neural network as of the current training iteration or as of an earlier training iteration to generate the pseudo-labels.

For each unlabeled point cloud in the set, the system generates a plurality of pseudo-elements based on the respective pseudo-label for the unlabeled point cloud. Each pseudo-element is a respective proper subset of the points in the point cloud. As a particular example, the pseudo-elements can include a pseudo background element that includes the points indicated as being part of the background by the pseudo-label for the point cloud. As another particular example, the pseudo-elements can include pseudo bounding box elements that each include points in a region of the point cloud that has been indicated as a measurement of an object by the pseudo-label for the point cloud.

The system generates augmented training data by augmenting the labeled training examples using the pseudo-elements generated for the unlabeled point clouds. In particular, for some or all of the labeled training examples, the system can insert one or more of the pseudo-elements into the point cloud in the labeled training example to generate an augmented point cloud.

The system then trains the neural network on the augmented training data.

The system can incorporate the above techniques into a population-based training framework, in which the system trains a population of training candidates over multiple training generations. At each generation, the system can use a proper subset of the training candidates that are the highest performing to generate the pseudo-labels. The system can then generate training data for each of the candidates using the pseudo-labels for the training generation as described above. Optionally, hyperparameters of the element-based augmentations can be part of the hyperparameters of the training process that are learned as part of the population-based training process.

The subject matter described in this specification can be implemented in particular embodiments so as to realize one or more of the following advantages.

Machine-learning models (e.g., neural networks) designed to process point cloud data, e.g., LiDAR point cloud data, to automatically detect and/or classify objects in an environment are critical in many applications, such as in robotic control and in autonomous vehicle motion planning. Training and testing those machine-learning models require a large number of training examples of sensor point cloud data with corresponding object labels. While collecting LiDAR point cloud data does not require significant additional costs, manually labeling the point cloud data can be time-consuming and expensive.

This specification provides an automatic machine-learning framework that includes data augmentation and semi-supervised learning for training neural networks for performing tasks such as object detection and classification from point clouds.

In one aspect, the described techniques implicitly exploit the properties of object detection tasks by decomposing the pseudo-labeled point clouds into elements and utilizing the pseudo-elements for data augmentation. This approach increases flexibility and improves the efficiency for data augmentation, since it enables choosing individual pseudo-elements for augmenting training data instead of choosing or rejecting a pseudo-labeled point cloud as a whole.

In another aspect, certain implementations of the described techniques perform augmentation operations with learnable hyperparameters to balance the labeled and unlabeled data as well as control the quality of pseudo-labeled point clouds.

In another aspect, certain implementations of the described techniques incorporate the pseudo labeling and data augmentation into a population-based training framework that searches a schedule for tuning the hyperparameters for the training data augmentation as well as generating pseudo labels. The population-based training framework facilitates choosing the optimal hyperparameters, and thus improving training efficiency.

In another aspect, the provided techniques are implemented as data augmentation, and thus are agnostic to the architecture of the neural networks to be trained, making them widely applicable.

Overall, the provided techniques improve the efficiency and quality of the training of a wide range of neural networks that perform point cloud processing tasks, such as detecting and/or classifying objects in point cloud data. Compared to existing methods, when the amount of labeled data is limited, the neural networks trained using the provided techniques have better performance, e.g., provide improved object detection accuracy, when performing a point cloud processing task.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network training system.

FIG. 1B illustrates an example of data augmentation.

FIG. 2A is a flow diagram illustrating an example process for neural network training.

FIG. 2B is a flow diagram illustrating an example process for performing data augmentation.

FIG. 3 is a flow diagram illustrating an example process for neural network training.

Like reference numbers and designations in the various drawings indicate like elements.

### DETAILED DESCRIPTION

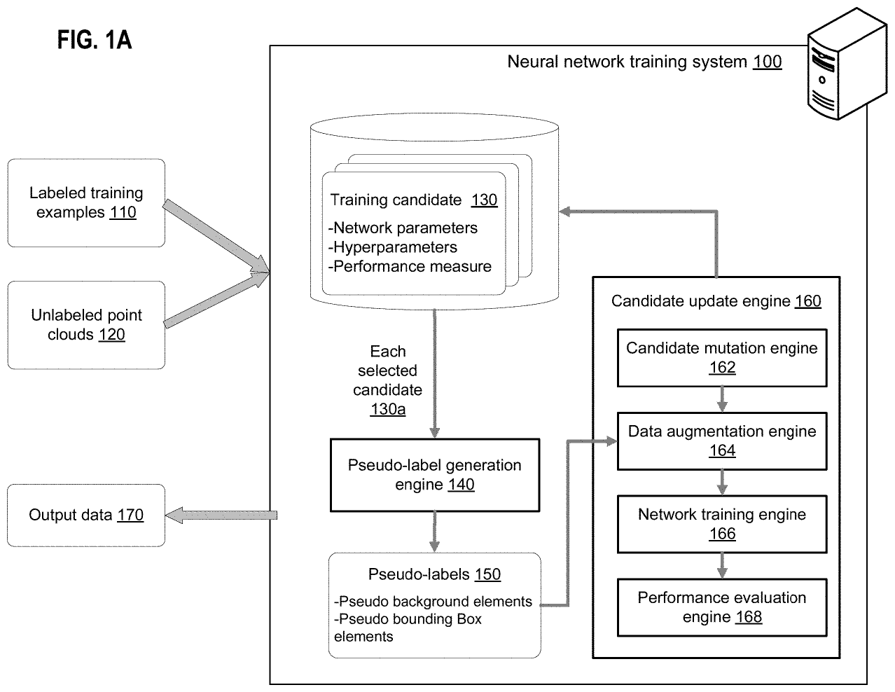

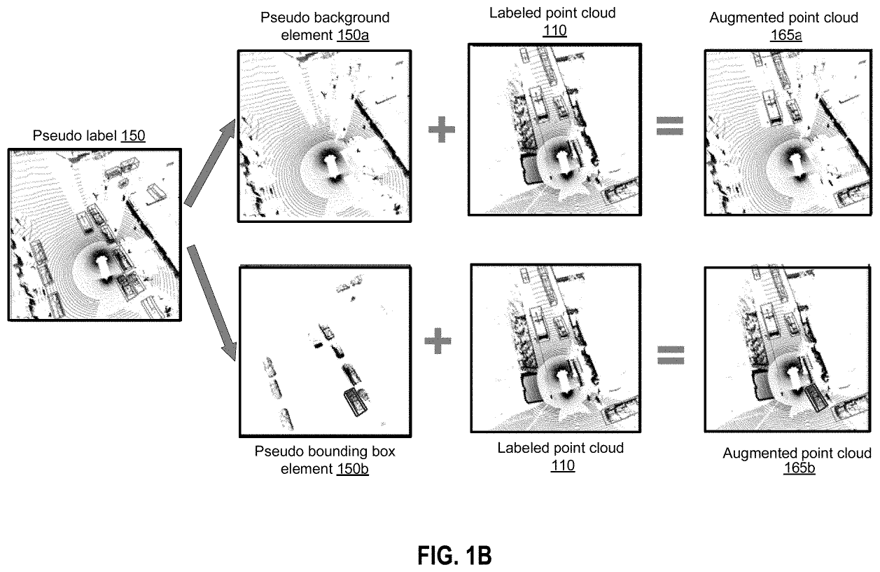

FIG. 1A shows an example of a neural network training system 100. The system 100 is an example of a system implemented as computer programs on one or more computers in one or more locations, in which the systems, components, and techniques described below can be implemented.

In general, the system 100 trains a neural network that is configured to process a point cloud to generate a network output for performing a point cloud processing task. The point cloud processing task can be a task that identifies one or more regions in the point cloud in the input point cloud. In a particular example, the point cloud processing task is an object detection task that generates regions in the point cloud that correspond to measurements of objects. In another example, the point cloud processing task is a point cloud segmentation task that segments the points in the point cloud into two or more classes.

The system 100 trains the neural network based on a data set of labeled training examples 110 and a data set of unlabeled point clouds 120.

Each labeled training example 110 includes (i) a point cloud and (ii) a respective label for the point cloud that specifies a target network output to be generated by the neural network by processing the point cloud.

For example, in a labeled training example 110, the point cloud can be a point cloud collected by a LiDAR system installed on a vehicle. The label for the point cloud can have been manually generated in an annotation process, and include data indicating regions in the point cloud that correspond to measurements of objects. As a particular example, the label can include parameters of one or more bounding boxes each including points in a region of the point cloud that correspond to a measurement of a respective object, e.g., a vehicle or a pedestrian.

The unlabeled point clouds 120 are point clouds for which a label is not available to the system for use in training the neural network. For example, point clouds data can be readily collected by a LiDAR system installed on an autonomous vehicle without manual annotation due to resource constraints.

In general, the system 100 incorporates the unlabeled point clouds 120 into the training of the neural network by generating respective pseudo-labels 150 for each unlabeled point cloud 120. The system can generate a plurality of pseudo-elements based on the respective pseudo-label for the unlabeled point cloud. The system generates augmented training data by augmenting the labeled training examples 110 using the pseudo-elements generated for the unlabeled point clouds 120. The system 100 then trains the neural network on the augmented training data.

The system 100 can incorporate the above techniques into a population-based training framework, in which the system trains a population of training candidates 130 over multiple training generations. At each generation, the system 100 can use a subset of the training candidates that are the highest performing to generate the pseudo-labels. The system 100 can then generate training data for each of the candidates 130 using the pseudo-labels for the training generation as described above. Optionally, hyperparameters of the element-based augmentations can be part of the hyperparameters of the training process that are learned as part of the population-based training process.

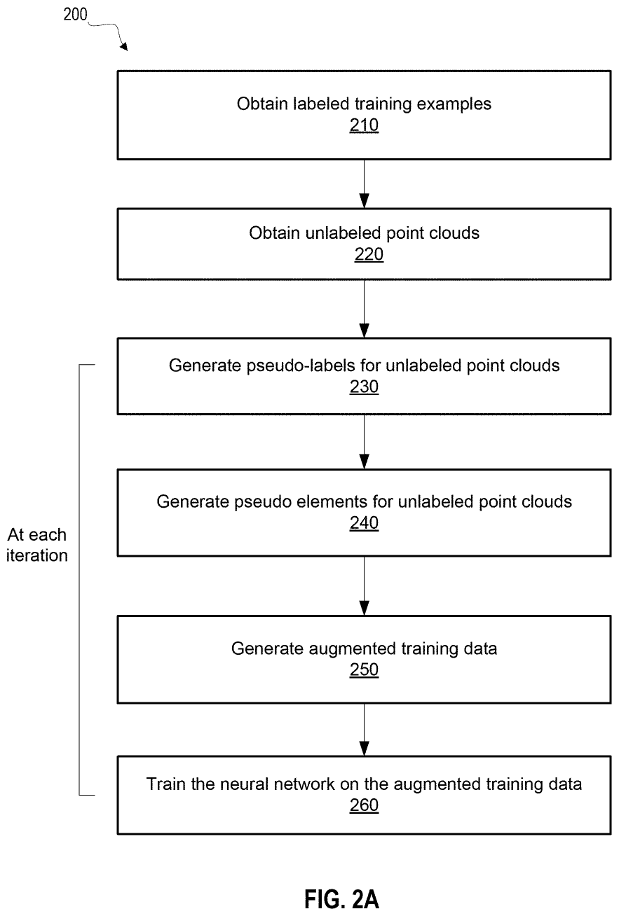

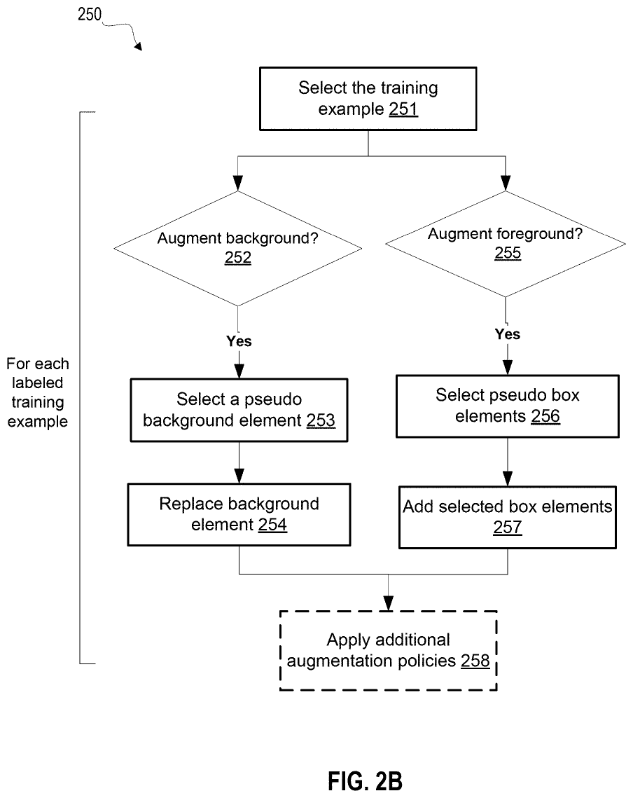

The description below describes the augmentation techniques being applied across a population with multiple candidates with reference to FIG. 1A. The described techniques can also be used when only a single neural network is being trained. In particular, an example process for training a single neural network is described with reference to FIG. 2A and FIG. 2B.

Referring to FIG. 1, the system 100 maintains data specifying a population of training candidates 130. For each training candidate 130, the maintained data specifies: (i) values for network parameters (e.g., weight and bias coefficients) for the neural network to be trained, (ii) a measure of performance of the training candidate on the point cloud processing task, and (iii) values for a set of hyperparameters of a training process.

Before the training starts, the system 100 can randomly initialize the population of training candidates 130.

For each of the M training candidates 130 in the population, and for each hyperparameter, the system 100 can randomly assign the hyperparameter drawn from a specific range. These hyperparameters can include one or more of: a probability, e.g., p∈[0,1], for augmenting background pixels of a labeled point cloud, the probability, e.g., f∈[0,1], for augmenting foreground pixels of a labeled point cloud, the confidence score threshold, e.g., T_{c}∈[0.5,1], for selecting a pseudo bounding box element, the number of selected pseudo bounding box elements, e.g., N_{b} ∈[0, 20], to augment the foreground points, as well as one or more hyperparameters for additional augmentation policies. The use of these hyperparameters in the training process will be described below.

The system 100 can perform a plurality of training generations to update the maintained data. In each training generation, the system 100 can train the neural network according to each of the M training candidates independently. The system 100 can perform the iterations of the training generations until a performance measure Pₜ at the t^{th} generation of a best-performing training candidate in the population converges. That is, when Pₜ plateaus and stops improving for a few generations, the system 100 can stop the iterations and select the network parameters of the best performing training candidate as the output data 170.

In each training generation, the system performs the following process to update the maintained data.

For each training generation, the system 100 can obtain a set of labeled training examples 110 for the iteration and a set of unlabeled point clouds 120 for the training generation. In one example, in each training generation, the system 100 can randomly select the set of labeled training examples 110 from a training data set, and randomly select the set of unlabeled point clouds 120 from a point cloud data set.

The system 100 selects, based on the respective measures of performance for each of the training candidates 130, one or more training candidates having the best measures of performance. For example, the system can select a threshold number of training candidates having the best measures of performance.

The system uses the selected training candidates 130a to generate pseudo-labels 150 for the set of unlabeled point clouds. In particular, for a selected training candidate 130a, the pseudo-label generation engine 140 generates the pseudo-label 150 for an unlabeled point cloud 120 by processing the unlabeled point cloud 120 using the neural network and in accordance with the values of the network parameters that are specified for the selected training candidate 130a.

In this specification, the term “pseudo-label” refers to a label that is predicted for an input by a machine-learning model, e.g., as indicated by an output of the neural network that processes the input. This is in contrast with the ground-truth label that is provided with a conventional training example.

In conventional population-based training methods, the population of models are only used to select hyperparameters. Thus the interactions of these models are limited to exploiting each other. By contrast, the system 100 in this specification selects the top-performing training candidates 130 to generate the pseudo labels 150, and thus can continuously improve the quality of the pseudo labels 150 as the top-performing training candidates in the population evolve over the training generations. This approach minimizes the error introduced by pseudo labels.

Based on the pseudo label generated for each unlabeled point cloud in the set, the system 100 can generate a plurality of pseudo-elements. Each pseudo-element is a respective proper subset of the points in respective the point cloud. The pseudo-elements can include a pseudo background element. The pseudo background element includes points that belong to a background of the point cloud according to the pseudo-label. The pseudo-elements can also include one or more pseudo bounding box elements. Each pseudo bounding box element includes points in a region of the point cloud that has been indicated as corresponding to a measurement of a respective object according to the pseudo-label. Each pseudo bounding box element can have a confidence score predicted by the neural network. The confidence score represents a likelihood that the pseudo bounding box element corresponds to an actual object.

Based on the pseudo-elements of the pseudo labels 150 generated from the selected training candidates 130a, the candidate update engine 160 updates each training candidate 130 in the population.

A candidate mutation engine 162 exploits the training candidates 130 in the population by inheriting and mutating them based on their respective performance measures. The mutation process allows replacing a poorly performing candidate with a better performer with certain random variation being introduced, allowing the training candidates dynamically evolve over the training generations. An example technique for mutating candidates is described in “Population-based training of neural networks,” arXiv preprint arXiv: 1711.09846, 2017, the entire content of which is hereby incorporated by reference in their entirety.

In general, for a particular training candidate 130 in the population, the candidate mutation engine 162 determines updated values of the network parameters for the training candidate based on (i) the performance measures and (ii) the values of the network parameters for the population of training candidates specified in the maintained data. The candidate mutation engine 162 further determines updated values of the hyperparameters for the training candidate based on (i) the performance measures and (ii) the values of the hyperparameters for the population of training candidates specified in the maintained data.

A data augmentation engine 164 generates augmented training data for the training candidate 130. The data augmentation engine 164 can augment at least some of the labeled training examples 110 using the pseudo-elements generated for the unlabeled point clouds 120. The values of one or more hyperparameters define how the augmented training data is generated using the pseudo-elements as described below.

The data augmentation engine 164 can determine whether to augment the background of the point cloud in the labeled training example. In a particular example, the data augmentation engine 164 can randomly determine, with the probability p, to augment the background of the point cloud for a labeled training example 110. The probability p can be a hyperparameter stored for the training candidate 130. The parameter p indicates a balance of augmented and un-augmented data, i.e., how much of the labeled data is to be augmented with pseudo background elements.

In response to determining to augment the background of the point cloud, the data augmentation engine 164 selects one of the pseudo background elements to be used in data augmentation. In some implementations, the data augmentation engine 164 can randomly select a pseudo background element from the pseudo background elements generated from the pseudo labels 150. The data augmentation engine 164 replaces, in the point cloud and with the selected pseudo background element, a background element that includes points that belong to a background of the point cloud according to the label for the point cloud.

The data augmentation engine 164 can further determine whether to augment a foreground of the point cloud in the labeled training example 130. In a particular example, the data augmentation engine 164 can randomly determine, with the specific probability f, to augment the foreground of the point cloud for a labeled training example. The probability f can be a hyperparameter stored for the training candidate 130. The parameter f indicates how much of the labeled data is to be augmented with pseudo bounding box elements.

In response to determining to augment the foreground, the data augmentation engine 164 selects one or more of the pseudo bounding box elements to be used for data augmentation.

In some implementations, the data augmentation engine 164 selects only pseudo bounding box elements that have a confidence score above the specified threshold T_{c}, which can be a hyperparameter stored for the training candidate 130. For example, the system can randomly select, from pseudo bounding box elements with confidence scores >T_{c}, a specific number N_{b} of pseudo bounding box elements to augment the foreground of the point cloud of the labeled training example. The number N_{b} can also be a hyperparameter stored for the training candidate 130. The confidence score threshold T_{c} controls the removal of the false-positive bounding boxes generated from the pseudo labels, which in turn controls the reduction of potential prediction error gradient in training the neural network to perform the point cloud processing task.

In some implementations, when selecting the pseudo bounding box elements, the data augmentation engine 164 selects only pseudo bounding box elements that do not collide with existing bounding box elements according to the label for the point cloud.

The data augmentation engine 164 adds each of the one or more selected pseudo bounding box elements to the point cloud. That is, the data augmentation engine 164 inserts the one or more selected pseudo bounding box elements into the point cloud in the labeled training example to generate an augmented point cloud. The data augmentation engine 164 further inserts respective bounding box information corresponding to the selected pseudo bounding box elements into the label of the labeled point cloud.

In some implementations, prior to adding the selected pseudo bounding box element to the point cloud, the data augmentation engine 164 can move each selected pseudo bounding box element to align the pseudo bounding box element with a ground plane of the point cloud of the labeled training example.

In one example, to align the selected pseudo bounding box elements and the ground plane of the point cloud of the labeled training example, the data augmentation engine 164 can perform a linear regression using the existing bounding boxes in the label for the point cloud to determine the ground plane. For example, the data augmentation engine 164 can use the (x, y, z) coordinates of the bottom center of each bounding box to estimate the ground plane. The data augmentation engine 164 can align the z coordinate of a selected pseudo bounding box element to the ground plane based on the linear fitting.

In some implementations, when adding the selected pseudo bounding box elements to the point, the system removes, from the point cloud, any points that (i) collide with any of the one or more selected pseudo bounding box elements and (ii) are in a background of the point cloud according to the label for the point cloud.

In some implementations, the data augmentation engine 164 applies one or more additional point cloud data augmentation policies to the point cloud in the labeled training example, including, one or more of: a random rotation policy, a world-scaling policy, a global translate noise policy, a frustum dropout policy, a frustum noise policy, and a random drop laser points policy. These additional augmentation policies are in general geometry-based augmentations. Example techniques for applying such augmentations are described in in “Improving 3d object detection through progressive population-based augmentation,” arXiv: 2004.00831, 2020, the entire content of which is hereby incorporated by reference in its entirety.

Based on at least a subset of the augmented training data, a network training engine 166 trains the neural network. Concretely, for each of the M training candidates 130, the network training engine 166 trains the neural network starting from the updated values of the network parameters for the training candidate 130 to determine new values of the network parameters. The network training engine 166 can update network parameters of the neural network using any appropriate optimizer for neural network training, e.g., SGD, Adam, or rmsProp.

After the neural network is trained on the augmented training data, a performance evaluation engine 168 determines an updated measure of performance for the training candidate 130 based on a performance on the point cloud processing task of the neural network having the updated values of the network parameters.

The performance evaluation engine 168 can evaluate the performance of the neural network in the training candidate 130 on validation data for performing the point cloud processing task. In a particular implementation, for each training candidate 130 in each training generation, the performance evaluation engine 168 can randomly select a portion (e.g., 10%) of a validation data set as a mini validation set to save the computational cost when evaluating the neural network performance.

Based on the outputs of the network training engine 166 and the performance evaluation engine, the candidate update engine 160 updates the maintained data for the training candidate 130. The updated data specifies: (i) the new values of the network parameters, (ii) the updated values of the hyperparameters, and (iii) the updated measure of performance.

FIG. 1B illustrates an example of data augmentation. The pseudo label 150 generated for an unlabeled point cloud indicates a background and a plurality of predicted bounding boxes. The system can generate a pseudo background element 150a and one pseudo bounding box element 150b (as indicated by the bounding box). The system generates one example of an augmented point cloud 165a by replacing the background pixels of a labeled point cloud 110 with the pseudo background element 150a. The system generates another example of the augmented point cloud 165b by incorporating the pseudo bounding box element 150b into the labeled point cloud 110.

FIG. 2A is a flow diagram illustrating an example process 200 for performing neural network training. For convenience, the process 200 will be described as being performed by a system of one or more computers located in one or more locations. For example, a neural network training system, e.g., the neural network training system 100 of FIG. 1A, appropriately programmed in accordance with this specification, can perform the process 200.

The goal of the process 200 is to train a neural network that is configured to process a point cloud to generate a network output for performing a point cloud processing task. The point cloud processing task can be a task that identifies one or more regions in the point cloud in the input point cloud. In a particular example, the point cloud processing task is an object detection task that generates regions in the point cloud that correspond to measurements of objects. In another example, the point cloud processing task is a point cloud segmentation task that segments the points in the point cloud into two or more classes.

In step 210, the system obtains a set of labeled training examples. Each labeled training example includes (i) a point cloud and (ii) a respective label for the point cloud that specifies a target network output to be generated by the neural network by processing the point cloud.

For example, a label for a particular point cloud can include data indicating regions in the point cloud that correspond to measurements of objects. As a particular example, the label can include parameters of one or more bounding boxes each including points in a region of the point cloud that correspond to a measurement of a respective object, e.g., a vehicle or a pedestrian.

In step 220, the system obtains a set of unlabeled point clouds. The unlabeled point clouds are point clouds for which a label is not available to the system for use in training the neural network.

In some implementations, the system can perform an interactive training process that includes generating the respective pseudo-label, generating the plurality of pseudo-elements, generating the augmented training data, and training the neural network on the augmented training data.

At each specific iteration of an iterative training process, the system can perform step 230-step 260 for training the neural network.

In step 230, the system generates a respective pseudo-label for each unlabeled point cloud. The pseudo-label is a prediction of a label for the unlabeled point cloud.

In some implementations, to generate the respective pseudo-label for an unlabeled point cloud, the system processes the unlabeled point cloud using a neural network. In some cases, the neural network can be a pre-trained neural network. In some other cases, the system repeatedly generates sets of pseudo-labels at different training iterations during the performance of a training process to train the neural network. In these cases, the system can use one or more instances of the neural network as of the current training iteration or as of an earlier training iteration to generate the pseudo-labels. That is, the system can process the unlabeled point cloud using a neural network with the network parameters of the current iteration of the iterative training process, or the system can process the unlabeled point cloud using the neural network with the network parameters of an earlier iteration of the iterative training process.

In some implementations, the pseudo label associates each pseudo bounding box element with a confidence score that represents a likelihood that the pseudo bounding box element corresponds to an actual object.

In some implementations, the system can process each unlabeled point cloud using a different, already trained neural network to generate the pseudo-label for the unlabeled point cloud.

In step 240, for each unlabeled point cloud in the set, the system generates a plurality of pseudo-elements based on the respective pseudo-label for the unlabeled point cloud. Each pseudo-element is a respective proper subset of the points in the point cloud.

In some implementations, the pseudo-elements include a pseudo background element. The pseudo background element includes points that belong to a background of the point cloud according to the pseudo-label. The pseudo-elements can also include one or more pseudo bounding box elements. Each pseudo bounding box element includes points in a region of the point cloud that has been indicated as corresponding to a measurement of a respective object according to the pseudo-label.

In step 250, the system generates augmented training data by augmenting the labeled training examples using the pseudo-elements generated for the unlabeled point clouds. In particular, for some or all of the labeled training examples, the system can insert one or more of the pseudo-elements into the point cloud in the labeled training example to generate an augmented point cloud.

An example of the training data augmentation process 250 is described with reference to FIG. 2B. The system can perform the process 250 for each labeled training example in the set of one or more labeled training examples.

Referring to FIG. 2B, in step 251, the system selects a particular labeled training example from the set of labeled training examples.

In step 252, the system determines whether to augment the background of the point cloud in the labeled training example.

In a particular example, the system can randomly determine to augment the background of the point could for a labeled training example with a probability p. Thus, the probability of not to augment the background is (1−p). p is a parameter that can be chosen to tune how much of the labeled data is augmented with pseudo background elements.

In response to determining to augment the background of the point cloud, in step 253, the system selects one of the pseudo background elements. In some implementations, the system can randomly select a pseudo background element from the pseudo background elements generated from the pseudo labels.

In step 254, the system replaces, in the point cloud and with the selected pseudo background element, a background element that includes points that belong to a background of the point cloud according to the label for the point cloud.

In step 255, the system determines whether to augment a foreground of the point cloud in the labeled training example.

In a particular example, the system can randomly determine to augment the foreground of the point cloud for a labeled training example with a specific probability f and not to augment the foreground with probability (1−f). f is a parameter that can be chosen to tune how much of the labeled data is augmented with pseudo bounding box elements.

In response to determining to augment the foreground, in step 256, the system selects one or more of the pseudo bounding box elements.

In some implementations, the system selects only pseudo bounding box elements that have a confidence score above a specified threshold T_{c}. For example, the system can randomly select, from pseudo bounding box elements with confidence scores >T_{c}, a specific number of pseudo bounding box elements to augment the foreground of the point cloud of the labeled training example. The confidence score threshold T_{c} and the number of selected pseudo bounding box elements N_{b} are two other parameters that can be chosen to tune how the pseudo bounding box elements are selected for data augmentation. For example, the confidence score threshold T_{c} can be used to control the removal of the false-positive bounding boxes generated from the pseudo labels, which in turn controls the reduction of potential prediction error gradient in training the neural network to perform the point cloud processing task.

In some implementations, when selecting the pseudo bounding box elements, the system selects only pseudo bounding box elements that do not collide with existing bounding box elements according to the label for the point cloud.

In step 257, the system adds each of the one or more selected pseudo bounding box elements to the point cloud. That is, the system inserts the one or more selected pseudo bounding box elements into the point cloud in the labeled training example to generate an augmented point cloud. The system further inserts the respective bounding box information (e.g., the bounding box parameters) corresponding to the selected pseudo bounding box elements into the label of the labeled point cloud.

In some implementations, prior to adding the selected pseudo bounding box element to the point cloud, the system can move each selected pseudo bounding box element to align the pseudo bounding box element with a ground plane of the point cloud.

In some implementations, when adding the selected pseudo bounding box elements to the point, the system removes, from the point cloud, any points that (i) collide with any of the one or more selected pseudo bounding box elements and (ii) are in a background of the point cloud according to the label for the point cloud.

In some implementations, the system applies one or more additional point cloud data augmentation policies to the point cloud in the labeled training example, including, one or more of: a random rotation policy, a world-scaling policy, a global translate noise policy, a frustum dropout policy, a frustum noise policy, and a random drop laser points policy.

Referring back to FIG. 2A, in step 260, the system trains the neural network on the augmented training data. Based on the augmented training data, the system can update network parameters of the neural network using any appropriate optimizer for neural network training, e.g., SGD, Adam, or rmsProp.

The system can iterate through steps 230-260 for K iterations. The iteration number K can be chosen according to the application for the trained neural networks to reach convergence.

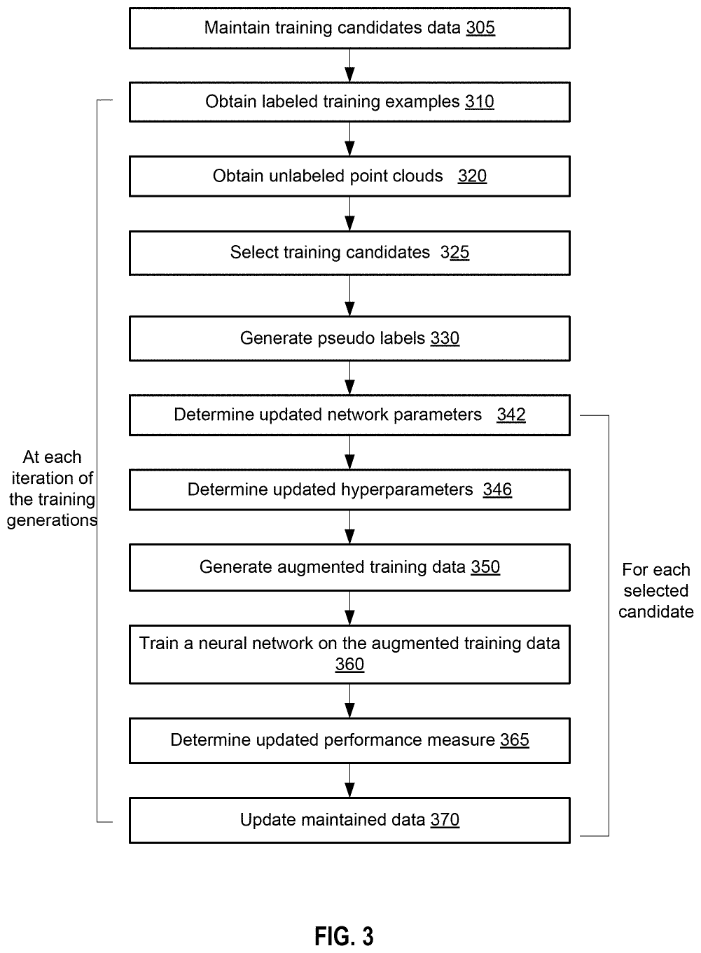

FIG. 3 is a flow diagram illustrating another example process 300 for performing neural network training. For convenience, the process 300 will be described as being performed by a system of one or more computers located in one or more locations. For example, an object detection system, e.g., the neural network training system 100 of FIG. 1A, appropriately programmed in accordance with this specification, can perform the process 300.

In step 305, the system maintains data specifying a population of training candidates. For each training candidate, the maintained data specifies: (i) values for the network parameters, (ii) a measure of performance of the training candidate on the point cloud processing task, and (iii) values for a set of hyperparameters of a training process.

The system can perform a plurality of training generations to update the maintained data. In each training generation, the system can train each of the M training candidates independently. The system can perform the iterations of the training generations until the M training candidates in the population converges. In each iteration of the training generations, the system performs steps 310-370 to update the maintained data.

In step 310, the system obtains a set of labeled training examples. Each labeled training example includes (i) a point cloud and (ii) a respective label for the point cloud that specifies a target network output to be generated by the neural network by processing the point cloud.

In step 320, the system obtains a set of unlabeled point clouds.

In step 325, the system selects, based on the respective measures of performance for each of the training candidates, one or more training candidates having the best measures of performance.

For example, the system can select a threshold number of training candidates having the best measures of performance.

In step 330, the system generates, using the one or more selected training candidates, a respective pseudo-label for each unlabeled point cloud that is a prediction of a label for the unlabeled point cloud.

For example, the system can identify one of the selected training candidates, and generate the pseudo-label for the unlabeled point cloud by processing the unlabeled point cloud using the neural network and in accordance with the values of the network parameters that are specified for the identified training candidate in the maintained data.

In step 340, for each unlabeled point cloud in the set, the system generates a plurality of pseudo-elements based on the respective pseudo-label for the unlabeled point cloud. The step is similar to step 240 with reference to FIG. 2A, and the implementation details are not repeated herein.

The system performs steps 342-370 for each training candidate in the population.

In step 342, the system determines updated values of the network parameters for the training candidate. The system can determine the updated network parameters based on (i) the performance measures and (ii) the values of the network parameters for the population of training candidates specified in the maintained data.

In step 346, the system determines updated values of the hyperparameters for the training candidate. The system can determine the updated hyperparameters based on (i) the performance measures and (ii) the values of the hyperparameters for the population of training candidates specified in the maintained data.

In step 350, the system generates augmented training data for the training candidate. The system can augment at least some of the labeled training examples using the pseudo-elements generated for the unlabeled point clouds. The values of one or more hyperparameters define how the augmented training data is generated using the pseudo-elements. The hyperparameters can include one or more of: a probability, e.g., p∈[0, 1], for augmenting background pixels of a labeled point cloud, the probability, e.g., f∈[0, 1], for augmenting foreground pixels of a labeled point cloud, the confidence score threshold, e.g., T_{c}∈[0.5,1], for selecting a pseudo bounding box element, the number of selected pseudo bounding box elements, e.g., N_{b} ∈[0, 20], to augment the foreground points, as well as one or more hyperparameters for additional augmentation policies.

The details of the implementation are similar to those of step 250 with references to FIG. 1A and FIG. 1B, and are not repeated herein.

In step 360, the system trains a neural network on at least a subset of the augmented training data by performing the training process. Concretely, the system trains the neural network starting from the updated values of the network parameters for the training candidate to determine new values of the network parameters.

In step 365, the system determines an updated measure of performance for the training candidate based on a performance on the point cloud processing task of the neural network having the updated values of the network parameters.

In step 370, the system updates the maintained data for the training candidate. The updated data specifies: (i) the new values of the network parameters, (ii) the updated values of the hyperparameters, and (iii) the updated measure of performance.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for training a neural network that is configured to process a network input comprising a point cloud to generate a network output for a point cloud processing task, the method comprising:
obtaining a set of labeled training examples, each labeled training example comprising (i) a point cloud and (ii) a respective label for the point cloud that specifies a target network output to be generated by the neural network by processing the point cloud;
obtaining a set of unlabeled point clouds;
generating a respective pseudo-label for each unlabeled point cloud that is a prediction of a label for the unlabeled point cloud;
for each unlabeled point cloud in the set, generating a plurality of pseudo-elements based on the respective pseudo-label for the unlabeled point cloud, wherein each pseudo-element is a respective proper subset of the points in the point cloud;
generating augmented training data by augmenting the labeled training examples using the pseudo-elements generated for the unlabeled point clouds; and
training the neural network on the augmented training data.

2. The method of claim 1, wherein the point cloud processing task is a task that identifies one or more regions in the point cloud in the network input.

3. The method of claim 2, wherein generating the plurality of pseudo-elements comprises:
generating a pseudo background element that includes points that belong to a background of the point cloud according to the pseudo-label; and
generating one or more pseudo bounding box elements that each include points that correspond to a measurement of a respective object according to the pseudo-label.

4. The method of claim 3, wherein generating augmented training data by augmenting the labeled training examples using the pseudo-elements generated for the unlabeled point clouds comprises, for each of one or more of the labeled training examples:
determining whether to augment a background of the point cloud in the labeled training example;
in response to determining to augment the background of the point cloud:
selecting one of the pseudo background elements; and
replacing, in the point cloud and with the selected pseudo background element, a background element that includes points that belong to a background of the point cloud according to the label for the point cloud.

5. The method of claim 4, wherein determining whether to augment a background of the point cloud in the labeled training example comprises:
determining to augment the background with probability p and determining not to augment the background with probability 1−p.

6. The method of claim 3, wherein generating augmented training data by augmenting the labeled training examples using the pseudo-elements generated for the unlabeled point clouds comprises, for each of one or more of the labeled training examples:
determining whether to augment a foreground of the point cloud in the labeled training example;
in response to determining to augment the foreground of the point cloud:
selecting one or more of the pseudo bounding box elements; and
adding each of the one or more selected pseudo bounding box elements to the point cloud.

7. The method of claim 6, wherein determining whether to augment a foreground of the point cloud in the labeled training example comprises:
determining to augment the foreground with probability f and determining not to augment the foreground with probability 1−f.

8. The method of claim 6, wherein adding each of the one or more selected pseudo bounding box elements to the point cloud comprises:
prior to adding each of the one or more selected pseudo bounding box elements to the point cloud, rotating the each of the one or more selected pseudo bounding box elements to align the pseudo bounding box element with a ground plane of the point cloud.

9. The method of claim 6, wherein adding each of the one or more selected pseudo bounding box elements to the point cloud comprises:
removing, from the point cloud, any points that (i) collide with any of the one or more selected pseudo bounding box elements and (ii) are in a background of the point cloud according to the label for the point cloud.

10. The method of any one of claim 6, wherein selecting one or more of the pseudo bounding box elements comprises:
selecting only pseudo bounding box elements that do not collide with existing bounding box elements according to the label for the point cloud.

11. The method of any one of claim 6, wherein the pseudo label associates each pseudo bounding box element with a confidence score that represents a likelihood that the pseudo bounding box element corresponds to an actual object, and wherein selecting one or more of the pseudo bounding box elements comprises:
selecting only pseudo bounding box elements that have a confidence score above a specified threshold.

12. A method performed by one or more computers for training a neural network having a plurality of network parameters and that is configured to process a network input comprising a point cloud in accordance with the network parameters to generate a network output for a point cloud processing task, the method comprising:
maintaining data specifying a population of training candidates, the maintained data specifying, for each training candidate:
(i) values for the network parameters,
(ii) a measure of performance of the training candidate on the point cloud processing task, and
(iii) values for a set of hyperparameters of a training process; and
at each of a plurality of training generations:
obtaining a set of labeled training examples, each labeled training example comprising a point cloud and a label for the point cloud that specifies a target network output to be generated by the neural network by processing a network input that includes the point cloud;
obtaining a set of unlabeled point clouds;
selecting, based on the respective measures of performance for each of the training candidates, one or more training candidates having the best measures of performance;
generating, using the one or more selected training candidates, a respective pseudo-label for each unlabeled point cloud that is a prediction of a label for the unlabeled point cloud;
generating a plurality of pseudo-elements based on the respective pseudo-label for the unlabeled point cloud, wherein each pseudo-element is a respective proper subset of the points in the point cloud;
for each training candidate in the population:
determining updated values of the network parameters for the training candidate based on (i) the performance measures and (ii) the values of the network parameters for the population of training candidates specified in the maintained data;
determining updated values of the hyperparameters for the training candidate based on (i) the performance measures and (ii) the values of the hyperparameters for the population of training candidates specified in the maintained data;
generating augmented training data for the training candidate by augmenting at least some of the labeled training examples using the pseudo-elements generated for the unlabeled point clouds, wherein at least a portion of the values of hyperparameters define how the augmented training data is generated using the pseudo-elements;
training a neural network on at least a subset of the augmented training data by performing the training process, comprising training the neural network starting from the updated values of the network parameters for the training candidate to determine new values of the network parameters;
determining an updated measure of performance for the training candidate based on a performance on the point cloud processing task of the neural network having the updated values of the network parameters; and
updating the maintained data to specify, for the training candidate:
(i) the new values of the network parameters;
(ii) the updated values of the hyperparameters; and
(iii) the updated measure of performance.

13. The method of claim 12, wherein the point cloud processing task is a task that identifies one or more regions in the point cloud in the network input.

14. The method of claim 13, wherein generating the plurality of pseudo-elements comprises:
generating a pseudo background element that includes points that belong to a background of the point cloud according to the pseudo-label; and
generating one or more pseudo bounding box elements that each include points that correspond to a measurement of a respective object according to the pseudo-label.

15. The method of claim 14, wherein generating augmented training data by augmenting the labeled training examples using the pseudo-elements generated for the unlabeled point clouds comprises, for each of one or more of the labeled training examples:
determining whether to augment a background of the point cloud in the labeled training example;
in response to determining to augment the background of the point cloud:
selecting one of the pseudo background elements; and
replacing, in the point cloud and with the selected pseudo background element, a background element that includes points that belong to a background of the point cloud according to the label for the point cloud.

16. The method of claim 15, wherein determining whether to augment a background of the point cloud in the labeled training example comprises:
determining to augment the background with probability p and determining not to augment the background with probability 1−p, wherein the value of p is one of the set of hyperparameters of the training process.

17. The method of claim 14, wherein generating augmented training data by augmenting the labeled training examples using the pseudo-elements generated for the unlabeled point clouds comprises, for each of one or more of the labeled training examples:
determining whether to augment a foreground of the point cloud in the labeled training example;
in response to determining to augment the foreground of the point cloud:
selecting one or more of the pseudo bounding box elements; and
adding each of the one or more selected pseudo bounding box elements to the point cloud.

18. The method of claim 17, wherein determining whether to augment a foreground of the point cloud in the labeled training example comprises:
determining to augment the foreground with probability f and determining not to augment the foreground with probability 1-f, wherein the value off is one of the hyperparameters in the set of hyperparameters.

19. A system comprising one or more computers and one or more storage devices storing instructions that are operable, when executed by the one or more computers, to cause the one or more computers to perform training of a neural network that is configured to process a network input comprising a point cloud to generate a network output for a point cloud processing task, the training comprising:
obtaining a set of labeled training examples, each labeled training example comprising (i) a point cloud and (ii) a respective label for the point cloud that specifies a target network output to be generated by the neural network by processing the point cloud;
obtaining a set of unlabeled point clouds;
generating a respective pseudo-label for each unlabeled point cloud that is a prediction of a label for the unlabeled point cloud;
for each unlabeled point cloud in the set, generating a plurality of pseudo-elements based on the respective pseudo-label for the unlabeled point cloud, wherein each pseudo-element is a respective proper subset of the points in the point cloud;
generating augmented training data by augmenting the labeled training examples using the pseudo-elements generated for the unlabeled point clouds; and
training the neural network on the augmented training data.

20. A computer storage medium encoded with instructions that, when executed by one or more computers, cause the one or more computers to perform training of a neural network that is configured to process a network input comprising a point cloud to generate a network output for a point cloud processing task, the training comprising:
obtaining a set of labeled training examples, each labeled training example comprising (i) a point cloud and (ii) a respective label for the point cloud that specifies a target network output to be generated by the neural network by processing the point cloud;
obtaining a set of unlabeled point clouds;
generating a respective pseudo-label for each unlabeled point cloud that is a prediction of a label for the unlabeled point cloud;
for each unlabeled point cloud in the set, generating a plurality of pseudo-elements based on the respective pseudo-label for the unlabeled point cloud, wherein each pseudo-element is a respective proper subset of the points in the point cloud;
generating augmented training data by augmenting the labeled training examples using the pseudo-elements generated for the unlabeled point clouds; and
training the neural network on the augmented training data.
